(19) United States
(12) Patent Application Publication
(10) Pub. No.: US 2026/0361974 A1
(43) Pub. Date: Nov. 12, 2026

(54) BASEBOARD MANAGEMENT CONTROLLER-BASED GENERATION OF EARLY VIDEO FOR SERVERS-ON-A-CHIP

(71) Applicant: HEWLETT PACKARD ENTERPRISE DEVELOPMENT LP, Spring, TX (US)

(72) Inventor: Darrell R. Haskell, Spring, TX (US)

(21) Appl. No.: 19/201,023

(22) Filed: May 7, 2025

(51) Int. Cl. H04N 21/81; H04N 21/443

(52) U.S. Cl. CPC H04N 21/816; H04N 21/4432

(57) ABSTRACT

A technique includes a baseboard management controller controlling a video display interface of a computer platform responsive to an early stage of a boot of a host of the computer platform. The baseboard management controller controlling the video display interface includes receiving, from a server-on-a-chip (SoC) of the host, commands corresponding to early video content items. The baseboard management controller controlling the video display interface includes, responsive to the commands, communicating, using an out-of-band communication channel, with the video display interface to cause the video display interface to provide an output that corresponds to the early video content items. The technique includes, responsive to the host discovering the video display interface using an in-band communication channel associated with the video display interface, the baseboard management controller relinquishing control of the video display interface so that the video display interface is controlled by the host.

### BACKGROUND

A server may include a specialized service processor, called a “baseboard management controller,” or “BMC,” which monitors the physical state of the server and communicates with a management system through a management network. As examples of its roles, a BMC may monitor sensors (e.g., temperature sensors, cooling fan speed sensors and tampering sensors); monitor operating system status; monitor power statuses; log computer system events; and provide remotely-controlled management functions for the computer platform. Moreover, a BMC may allow operations to be performed when a host of the server is powered down.

### BRIEF DESCRIPTION OF THE DRAWINGS

FIG. 1 is a block diagram of a computer platform having a baseboard management controller (BMC)-based solution to generate early video containing video content provided by a server-on-a-chip (SoC), according to an example implementation.

FIG. 2 is a block diagram of a BMC-based early video architecture, according to an example implementation.

FIG. 3 is a block diagram of a communication channel architecture for communicating with a video display interface, according to example implementations.

FIG. 4 is a sequence flow diagram illustrating, in association with a host boot, communications among and actions taken by components of an early video solution, according to an example implementation.

FIG. 5 is a block diagram of a computer platform having a BMC that manages the generation of early video containing video content provided by an SoC, according to an example implementation.

FIG. 6 is a flow diagram depicting a technique to control a video display interface during a boot of a host of a computer platform to cause the video display interface to provide an output corresponding to a video content provided by an SoC, according to an example implementation.

FIG. 7 is an illustration of a storage medium that stores hardware processor-readable instructions that, when executed by a hardware processor, cause a baseboard management controller of a computer platform to control a video display interface during an early stage of a boot of a host of the computer platform to cause the video display interface to provide an output corresponding to early video content items provided by an SoC, according to an example implementation.

### DETAILED DESCRIPTION

A computer platform (e.g., a server) may have a video display interface for purposes of providing a local visual output for the platform. The video display interface provides signals that collectively correspond to a video output and when received by a display device, such as a television or monitor, produce a video. In the context that is used herein, a “video” refers to a stream or series of visual images.

A host of a computer platform may communicate with a video display interface using a primary, or in-band, communication channel. In an example, the host may, via the in-band communication channel, write data representing pixel color values and coordinates to either the video display interface or to a frame buffer that is associated with the video display interface.

A video display interface's in-band communication channel may be unavailable when the host first boots. The initial unavailability of the in-band communication channel during a host boot is due to the in-band communication channel undergoing a complex configuration. A “complex configuration,” in the context that is used herein, generally refers to a boot process involving the execution of firmware to set up multiple attributes of an in-band communication channel, including one or more of selecting a communication protocol for the in-band communication channel and selecting a data width of the in-band communication channel. A Peripheral Component Interconnect express (PCIe) link is an example of an in-band communication channel that is subject to a complex configuration. A PCIe link is not is not available in the initial part of a boot until the corresponding PCIe root complex is initialized and configured. The initialization and configuration of a PCIe root complex is associated with an ever-increasing amount of complex and sophisticated firmware execution. Waiting for firmware to configure a PCIe root complex means that there may be a substantial delay (e.g., seconds) after the beginning of a boot before any PCIe links that are associated with the PCIe root complex are available. In examples, the initialization and configuration of the PCIe root complex may involve, among other operations, PCIe link training to establish PCIe link parameters (e.g., data rates and equalization parameters); selecting whether particular PCIe lanes use PCIe or Compute Express Link (CXL) protocols; selecting lane groupings; selecting lane widths; and selecting link supply voltages.

For an endpoint device that is connected to a host by an in-band communication channel that is subject to complex configuration, the endpoint device cannot be discovered and therefore used by the host until the corresponding complex configuration is complete. For the case of a video display interface that is connected to a host via an in-band communication channel that is subject to complex configuration, a corresponding lengthy video availability delay (e.g., a delay of seconds) is imposed when the host boots.

A video availability delay may be more pronounced for a computer platform that has a server-on-a chip (SoC)-based architecture. A system-on-a-chip is a single semiconductor package that contains components, such as processing cores and a memory, for purposes of providing general purpose computing for a number of purposes, such as mobile user devices, client devices and servers. An SoC is a system-on-a-chip that is specialized to provide server functions. In an example, an SoC includes main components of a server, such as central processing unit (CPU) cores, a memory controller interface and a storage controller interface. An SoC may further include service processors.

When a computer platform containing an SoC begins a host boot, the SoC powers up, and then the SoC performs initialization operations (called “SoC initialization operations” herein). In examples, the SoC initialization operations include the SoC initializing its service processors, PCIe root ports and external interfaces (e.g., memory interfaces and storage interfaces). Moreover, other SoC initialization operations (e.g., initializing and training system memory) may extend outside of the SoC. A boot CPU core of the SoC does not begin loading and executing system firmware (e.g., basic input/output system (BIOS) and Unified Extensible Firmware Interface (UEFI) firmware) until the SoC initialization operations complete.

Upon receiving power, an SoC performs the SoC initialization operations before a main CPU core begins executing system firmware. The resulting video availability delay may span from several seconds to several minutes after the initiation of the host boot.

In accordance with example implementations that are described herein, an early video solution provides early video for an SoC, even though a video display interface of the computer platform is connected to an in-band communication channel that is subject to a complex configuration. The early video solution uses a secondary, or out-of-band, communication channel to control the video display interface during the initial, or early, part of the host boot. In the context used herein, “early” video refers to video that is associated with a host boot and occurs in the initial portion of the boot before the host's discovery of the video display interface. In an example, early video for a host begins at or near the initiation of the host boot (e.g., an initiation corresponding to a power on button being depressed) and ends at, near or after the discovery of the video display interface by the host. In an example, early video for SoC initialization operations begins at near the time that the SoC powers up. In an example, early video for SoC initialization operations ends at or near the time that a boot CPU core of the SoC is released from reset and begins executing system firmware. As can be appreciated, due to the early video solution, an initial unavailability of a video display interface's in-band communication channel during a host boot does not impact the computer platform's ability to provide early video.

The absence of early video for a computer platform may have detrimental consequences. In an example, a host boot may encounter a problem during SoC initialization or during firmware-based platform initialization, which causes the boot to fail (e.g., hang up, or stall) before the host discovers the video display interface. Because, for this example, the boot fails before the host discovers the video display interface, the computer platform does not produce any visual output. The visual output, if available, may have provided useful information from which a troubleshooter could have derived a reason to explain why the boot failed. Even if a boot survives a problem that occurs before the host's discovery of the video display interface, there may be no content in the video produced after the discovery of the video display interface to bring attention to the earlier encountered problem.

In another example of a detrimental consequence of not having early video, the absence of early video may lead to a perceived problem with a boot (even though the boot encounters no problems). Perceived boot problems may be especially prevalent for an SoC-based architecture, which has an ever-increasing complexity (e.g., an ever-increasing number of service processors that are initialized for a boot). In an example, the absence of early video for SoC initialization operations may not reveal the root causes of problems encountered during the operations. Moreover, due to the time for the SoC to complete its initialization operations, the nonavailability of early video for the SoC initialization operations may lead to a perceived problem with a boot (even though no problems occurred with the boot). In another example, the lack of early video may have financial implications. For example, the lack of early video may result in a warranty claim (e.g., a server replacement claim) when the actual problem (e.g., an unseated dual inline memory module (DIMM) that caused the boot to hang) is relatively minor and could have been readily resolved if early video was available to reveal the problem.

In accordance with example implementations that are described herein, a computer platform includes a host and a baseboard management controller (BMC) that manages the host. The BMC participates in an early video solution for the computer platform. More specifically, for purposes of producing early video, the BMC serves as an early video intermediary between the host and a video display interface that is yet to be discovered by the host. As described herein, the BMC may serve as an early video intermediary for both early video for SoC initialization operations and early video for firmware-based platform initialization.

In an example, at the beginning of a boot before system firmware execution begins, an SoC of a computer platform powers up and initializes hardware components and interfaces of the computer platform. In an example, the SoC participates in initialization and training of a system memory of the computer platform. The SoC, for this example, communicates with the BMC for purposes of generating early video content (e.g., error messages and initialization progress) related to the SoC initialization. The BMC uses a secondary, or out-of-band, communication channel to control the video display interface during the initial part of a host boot for purposes of producing the early video. Unlike the in-band communication channel, the out-of-band communication channel is not subject to a complex configuration.

In accordance with example implementations, the host asynchronously sends data to the BMC during the early video time period over a serial connection between the SoC and the BMC. More specifically, in accordance with example implementations, the host sends, via the serial connection, video content-related commands (called “display commands” herein) to the BMC. Each display command includes data that represents a command code that identifies a particular feature (called an “early video feature” herein) for the early video. In an example, an early video feature is a video content item (e.g., an error message or a progress bar status) to be included in the early video. In another example, an early video feature is an organization or effect (e.g., a scrolling effect or flashing text) to be applied to content of the early video.

The BMC, in one example, uses a look-up table to map received command codes to their respective early video features. The BMC writes to the video display interface using the out-of-band communication channel so that the early video has, or contains, the early video features that are indicated by the received command codes. The writes by the BMC may include writes to a display memory (e.g., a frame buffer) of the video display interface as well as writes to registers of a video controller of the video display interface. Moreover, the control of the video display interface by the BMC may involve the BMC reading from the video display interface, such as reading contents of the registers.

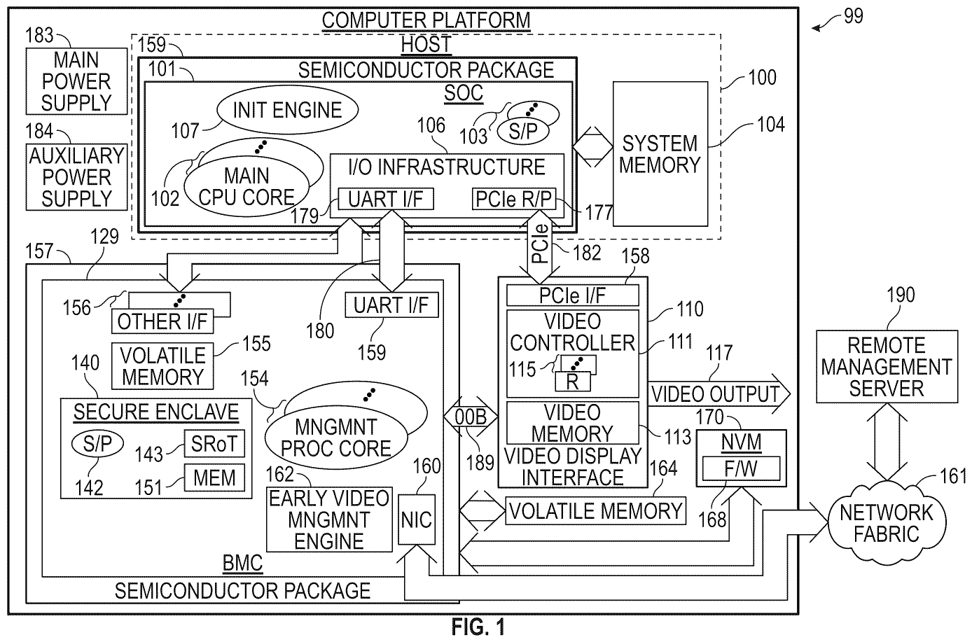

Referring to FIG. 1, as a more specific example, in accordance with some implementations, a computer platform 99, among its other components, includes a primary, or main, power supply 183; a secondary, or auxiliary, power supply 184; a host 100; a video display interface 110; and a baseboard management controller (BMC) 129. The auxiliary power supply 184 provides auxiliary power for the power consuming components of the BMC 129 when AC power is available (e.g., when a power cord for the computer platform 99 is plugged into a power receptacle). The main power supply 183, when enabled, provides main power to the power consuming components of the host 100.

In accordance with example implementations, the host 100, among other possible components, includes a server-on-a-chip (SoC) 101 and a system memory 104. The SoC 101 is contained in a single semiconductor package 159. The semiconductor package 159 contains hardware components, such as main CPU cores 102 that execute firmware (e.g. UEFI firmware) and software (e.g., applications, virtualization programs and an operating system, such as Linux or Windows) for the computer platform 99. As depicted in FIG. 1, in accordance with example implementations, the hardware components inside the semiconductor package 159 includes an input/output (I/O) infrastructure 106 and one or multiple service processors 103.

The semiconductor package 159 may have one of many different forms. In an example, the semiconductor package 159 contains a single semiconductor die in which all of the hardware components (e.g., the main CPU cores 102, the I/O infrastructure 106, and the service processors 103) of the SoC 101 are fabricated. In another example, the semiconductor package 159 includes multiple semiconductor dies that are mounted on a printed circuit board (PCB) substrate that interconnects the dies, and all of the hardware components of the SoC 101 are fabricated in these dies. In another example, a semiconductor package 159 contains multiple semiconductor dies that are interconnected by bonding wires, and all of the hardware components of the SoC 101 are fabricated in the dies.

In an example, the semiconductor package 159 is encapsulated. In another example, the semiconductor package 159 is not encapsulated. In other examples, the semiconductor package 159 may correspond to one of a variety of different containers, such as a surface mount package, a through-hole package, a ball-grid array package, a small outline package or a chip-scale package. Regardless of its particular form, in accordance with example implementations, the semiconductor package 159 operatively electrically couples its components to a printed circuit board assembly (PCBA) of the computer platform 99. In an example, the PCBA is a motherboard of the computer platform 99. In another example, the PCBA corresponds to a host processor module (HPM).

In the context that is used herein, a server-on-a-chip, or “SoC,” refers to a single semiconductor package that contains components to provide server functions, including CPU cores and a system memory controller. The SoC may include additional components that are part of the single semiconductor package, such as the storage processors 103, the I/O infrastructure 106, a storage interface, a network interface, and so forth.

In the context that is used herein, a “service processor” refers to a hardware component that operates independently from the main operating system for purposes of providing one or multiple management-related services and/or security-related services for a computer platform. In an example, a service processor 103 executes machine-readable instructions (e.g., instructions correspond to a micro-kernel) for purposes of providing its management-related and/or security-related services. In another example, a service processor 103 does not execute machine-readable instructions for purposes of providing its management-related and/or security-related services.

A management engine is an example of a service processor 103. A management engine may provide such features as out-of-band management services, a protected audio/video path (e.g., providing high-bandwidth digital content protection (HDCP)), a firmware-based trusted platform module (TPM), as well as provide other components and services for the computer platform 99.

A reliability, availability and serviceability (RAS) processor is another example of a service processor 103. The SoC 101 may include one or multiple RAS processors. A RAS processor may perform any of a number of functions, such detecting and correcting hardware-related errors (e.g., correcting memory errors and storage device errors), protecting data integrity, monitoring computer platform health, monitoring computer platform component performances, provided automatic failure recovery, providing failover, providing for preventative maintenance for the computer platform 99, providing diagnostic reporting, and so forth.

The I/O infrastructure 106 allows communications between the main CPU cores 102 and the BMC 129, as well as allows the main CPU cores 102 to communication with peripheral components, such as one or multiple storage drives; one or multiple Universal Serial Bus (USB) devices; I/O devices; and so forth. Moreover, the I/O infrastructure 106 may include one or multiple network interface controllers (NICs).

The I/O infrastructure 106 may take on any one of a number of different forms and architectures. In an example, the I/O infrastructure 106 includes one or multiple buses and one or multiple bridges connecting the buses. In another example, the I/O infrastructure 106 includes a memory controller and system memory interface. In another example, the I/O infrastructure 106 includes one or multiple storage device interfaces. In another example, the I/O infrastructure 106 includes accelerator interfaces. Depending on the particular implementation, the I/O infrastructure 106 may be fully or partially integrated with the main CPU cores 102 or may be separate from the main CPU cores 102.

In an example, the I/O infrastructure 106 includes one or multiple PCIe root complexes. In an example, each main CPU core 102 corresponds to a PCIe root complex and has an associated collection of PCIe root ports. For the example implementation that is depicted in FIG. 1, the I/O infrastructure 106 includes an exemplary PCIe root port 177, and the video display interface 110 is connected to the PCIe root port 177 by a PCIe link 182.

In accordance with example implementations, the PCIe link 182 serves as a primary, or in-band, communication channel over which the host 100 may control the video display interface 110 for purpose of generating video. Because the PCIe link 182 is subject to a complex configuration each time the host 100 boots, there is an initial period of time during a boot of the host 100 in which the video display interface 110 is undiscovered by the host 100. As such, without the early video solution that is described herein, early video for the computer platform 99 would otherwise be unavailable.

The PCIe link 182, similar to other PCIe links of the computer platform 99 is subject to complex configuration at the beginning of a host boot. The video display interface 110, cannot be discovered by PCIe enumeration until the complex configuration is complete. The complex configuration may be associated with the execution of complex and sophisticated firmware instructions, which may span several seconds. In an example, the complex configuration involves system firmware configuring a PCIe root complex associated with the PCIe link 182. Configuring the host 100 to bring the host 100 to a state in which the PCIe root complexes may be configured may involve the execution of several seconds of system firmware. For example, the PCIe root complex configuration may require system memory 104, CPU caches and/or other configured resources of host 100 to execute properly. Thus, the PCIe root complex configuration is performed after these operations and accordingly, does not finish until several seconds or minutes after power is applied to the host CPU After completion of the complex configuration and the discovery of the video display interface 110, the host 100 allocates system resources for the video display interface 110 and configures the video display interface 110 based on this allocation. The host 100 may thereafter communicate with the video display interface 110 via the PCIe root port 177.

The I/O infrastructure 106 includes a serial port, such as a port that corresponds to a Universal Asynchronous Receiver-Transmitter (UART) interface 179. Using the UART interface 179, the host 100 communicates with the BMC 129 for purposes of producing early video, as further described herein. The I/O infrastructure 106, in accordance with example implementations, includes other communication interfaces that are connected to respective communication interfaces 156 of the BMC 129. In an example, the I/O infrastructure 106 and the BMC 129 may communicate over one or multiple of the following communication links: an Inter-Integrated Circuit (or “I2C”) bus, an Improved I2C (or “I3C”) bus, a Serial Peripheral Interface (or “SPI”) bus, an enhanced SPI (or “eSPI”) bus, a system management bus (SMBus), as well as other communication links.

The BMC 129 powers up when auxiliary power provided by the auxiliary power supply 184 is available. The powering up of the host 100 (i.e., the enabling of the main power supply 183) occurs later in response to a host power on request. In an example, a host power on request corresponds to a power button of the computer platform 99 being depressed. In another example, a host power on request is initiated by the BMC 129 (e.g., the BMC 129 initiates a remotely requested power one of the computer platform 99 as part of the BMC's power management service) instead of the host power on request being initiated by a power button being depressed. A host power on request triggers a boot of the host 100. In the context that is used herein, a “boot” (or “boot up”) of a host refers to a process of starting up the host, beginning with power being provided to the host and ending with control of the host being passed to an operating system.

A host boot may first include a hardware initialization phase, or stage, and the hardware initialization stage is proceeded by the execution of system firmware that performs further platform initialization. Regarding the execution of system firmware, example implementations are described herein in which the computer platform 99 undergoes a “UEFI boot” and as part of the UEFI boot, executes UEFI system firmware for purposes of performing platform initialization and ultimately loading the operating system. All or part of the system firmware may not be UEFI firmware, however, in accordance with further implementations. For example, in accordance with further implementations, the computer platform 99 performs a “legacy-boot,” in which the computer platform 99 relies solely on the execution of legacy BIOS firmware for platform initialization and loading of the operating system. In another example, the computer platform 99 executes “Linux-boot” system firmware that contains some UEFI firmware, but driver execution environment (DXE) modules of the UEFI firmware are replaced with the Linux kernel. In another example, the computer platform 99 executes Coreboot system firmware to perform platform initialization. In another example, the computer platform 99 performs a Universal-Boot, or “U-boot,” in which the computer platform 99 executes a U-boot loader to load the operating system. The early video solution that is described herein provides early video regardless of the particular type of boot environment or technique used to boot the host 100.

In an example, responsive to receiving main power and powering up, the SoC 101 performs initialization operations that precede the execution of UEFI firmware by a boot main CPU 102 of the SoC 101. In an example, the initialization operations performed by the SoC 101 include the SoC 101 initializing the I/O infrastructure 106. In another example, the initialization operations by the SoC 101 include the SoC 101 participating in the initialization and training of the system memory 104. In another example, the initialization operations of the SoC 101 include the SoC initializing the service processors 103. In another example, the initialization operations of the SoC 101 include the SoC 101 initializing peripherals that are connected to the SoC 101.

In accordance with example implementations, the BMC 129, for each host boot, controls when (if at all) the execution of UEFI firmware begins. In accordance with example implementations, the main CPU cores 102 are held in reset when the main CPU cores 102 power up, and the BMC 129 controls when the main CPU cores 102 are released from reset. More specifically, the BMC 129 performs various checks for purposes of determining whether the main CPU cores 102 are allowed to be released from reset. In an example of the checks, the BMC 129 validates firmware 168 (e.g., firmware corresponding to a BMC firmware management stack image and the UEFI firmware) that is stored in a non-volatile memory 170 of the computer platform 99. In another example, the BMC 129 checks for hardware faults of the computer platform 99.

If the BMC 129 determines, responsive to the checks, that the boot of the host 100 is allowed to proceed with executing UEFI firmware, then the BMC 129 releases the main CPU cores 102 from reset. The release of the main CPU cores 102 from reset allows a designated boot main CPU core 102 to execute the UEFI firmware.

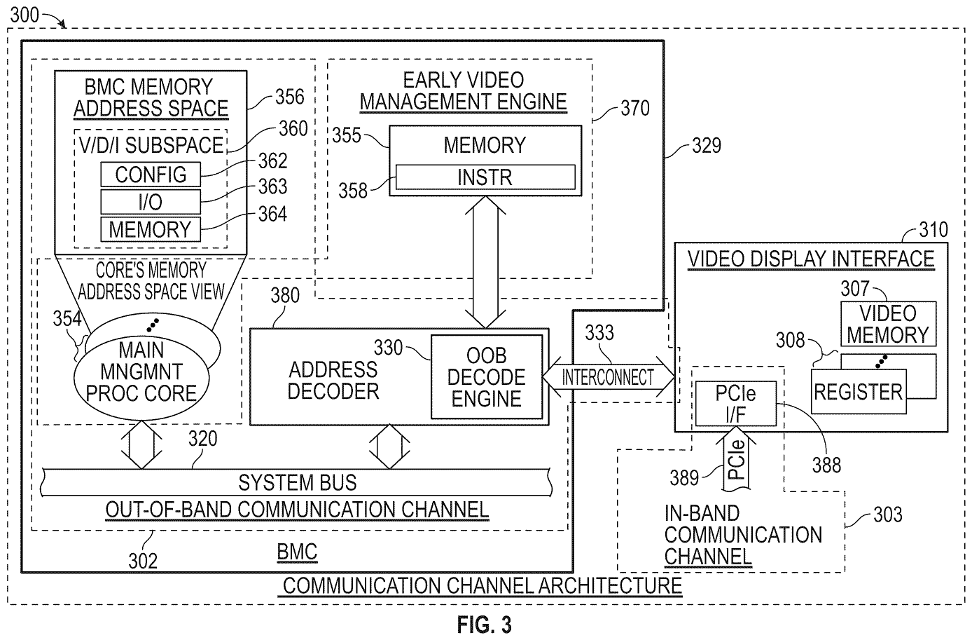

In accordance with example implementations that are described herein, the BMC 129 includes an early video management engine 162 (or “early video offload management engine 162”). The early video management engine 162 serves as an early video intermediary for the host 100 for purposes of providing early video. More specifically, in accordance with example implementations, responsive to a host power on request, the early video management engine 162 configures the video display interface 110 to be initially controlled by the engine 162. In accordance with example implementations, the configuration occurs via communications over an out-of-band communication channel 189. An example implementation of the out-of-band communication channel 189 is described below in connection with FIG. 3.

Still referring to FIG. 1, during the early part of a host's boot before the host's discovery of the video display interface 110, the host 100 communicates with the early video management engine 162 via a communication link 180. The communication link 180 may be considered an out-of-band communication channel between the SoC 101 and the BMC 129. In an example and as depicted in FIG. 1, the communication link 180 is an asynchronous serial data exchange connection between the UART interface 179 of the SoC 101 and a UART interface 159 of the BMC 129. In accordance with further implementations, communication technologies links other than UART-based communication may be used for the communication link 180, such as an I2C bus, an I3C bus, a SPI bus, an eSPI bus, an SMBus, and so forth. In these implementations, the early video management engine 162 may communicate with the SoC 101 using one of the BMC's other communication interfaces 156.

The host 100 includes one or multiple early video content generators that are present at different times during the early part of the host boot before the host's discovery of the video display interface 110. An SoC initialization engine 107 that performs initialization operations for the SoC 101 in response to the SoC 101 powering up is an example of an early video content generator. UEFI firmware that executes when the main CPU cores 102 are released from reset is another example of an early video content generator. An early video content generator, in general, determines content for the early video and sends, to the BMC's early video management engine 162, data representing video content-related commands, which are referred to herein as “display commands.”

In a more specific example, during the initial stage of a host boot, the SoC initialization engine 107 performs initialization operations for the SoC 101 prior to the execution of UEFI firmware by the main CPU cores 102. In association with the initialization operations, the SoC initialization engine 107 determines features (called “early video features” herein) for the early video, determines display commands corresponding to these features, and sends, via the communication link 180, the display commands to the early video management engine 162.

In an example, the SoC initialization engine 107 determines that a startup image, an early video feature, is to be included in the early video to visually indicate the beginning of the host boot, and the SoC initialization engine 107 sends, to the early video management engine 162, a display command that corresponds to the startup image. In another example, the SoC initialization engine 107 determines that a certain percentage of progress of the SoC's initialization, an early video feature, is to be visually displayed, and the SoC initialization engine 107 sends, to the early video management engine 162, a display command that corresponds to the progress bar percentage. In another example, the SoC initialization engine 107 determines that an error has occurred during the SoC's initialization, and the SoC initialization engine 107 sends, to the early video management engine 162, a display command that corresponds to a specific error message, an early video feature, to be included in the early video. In another example, the SoC initialization engine 107 sends, to the early video management engine 162, a display command that corresponds to a message, an early video feature, indicating that a particular phase of the SoC's initialization is occurring. In another example, the SoC initialization engine 107 determines that the SoC's initialization is complete, and the SoC initialization engine 107 sends, to the early video management engine 162, a display command that corresponds to a message, an early video feature, that indicates that the SoC's initialization is complete.

After the SoC initialization is complete, UEFI firmware (another example of an early video content generator) begins to execute, assuming that the BMC 129 allows the main CPU cores 102 to be released from reset. The UEFI firmware performs a sequence of UEFI platform initialization phases. In association with the sequence of UEFI platform initialization phases, the UEFI firmware determines early video features, determines display commands corresponding to the early video features, and sends, via the communication link 180, corresponding display commands to the early video management engine 162.

In an example, the UEFI firmware determines that an image, an early video feature, is to be included in the early video to visually indicate the beginning of UEFI firmware execution, and the UEFI firmware sends, to the early video management engine 162, a display command that corresponds to the startup image. In another example, the UEFI firmware determines that a certain percentage of progress of the host boot (an example of an early video feature) or a certain percentage of progress of the UEFI initialization (another example of an early video feature) is to be included in the early video, and the UEFI firmware sends, to the early video management engine 162, a display command that corresponds to the progress bar percentage. In another example, the UEFI firmware determines that a message (an early video feature) that represents the current UEFI initialization phase is to be included in the early video, and the UEFI firmware sends, to the early video management, a corresponding display command. In another example, UEFI firmware determines that an error has occurred, and the UEFI firmware sends, to the early video management engine 162, a display command that corresponds to a specific error message, an early video feature, to be included in the early video.

An early video feature may, in an example, be a video content item. In examples, an early video feature may be a progress bar, a progress bar update percentage, a message, an icon, an image, a logo, a single character, multiple characters, or any other visually displayed element or group of elements. In another example, an early video feature may be an organization or effect to be applied to the early video, such as a rearrangement of already display elements of the early video, flashing text, scrolling, and so forth.

In an example, a display command corresponds to a sequence of American Standard Code for Information Interchange (ASCII) characters representing a string of characters. In an example, the sequence has an order that corresponds to the order in which bits are communicated over the communication link 180. In an example, a beginning part, or prefix, of the string or another designated part of the string (as another example), serves as a label to indicate that the remainder of the string corresponds to a code (called a “command code” herein) that identifies an early video feature. In an example, a prefix of the string represents an escape sequence of characters, which alerts the early video management engine 162 to reception of a display command over the communication link 180.

The early video management engine 162, in one example, uses a look-up table to map a given command code to the specific corresponding early video feature, and the early video management engine 162 accesses (e.g., writes to) the video display interface 110 using the out-of-band communication channel 189 to apply the early video feature to the early video. In another example, the early video management engine 162 uses a collection of rules (e.g., “if-then” rules) to map the given command code to the early video feature. In an example, the early video management engine 162 writes, using the out-of-band communication channel 189, to a video memory 113 (e.g., a video display memory) of the video display interface 110 for purposes of including a video content item in the early video. In another example, the early video management engine 162 writes, using the out-of-band communication channel 189, to a register 115 of a video controller 111 of the video display interface 110 for purposes of applying an effect to the early video. In another example, for purposes of including applying a particular early video feature to the early video, the early video management engine 162 may initiate multiple transactions with video display interface 110 via the out-of-band communication channel 189, including one or multiple write transactions, one or multiple read transactions, or a combination of the foregoing.

The display commands correspond to a compact and communication efficient way for the SoC 101 (e.g., the SoC 101 under control of the SoC initialization engine 107 or the SoC 101 under control of firmware executing on a main CPU core 102 of the SoC 101) to inform the early video management engine 162 about early video features to include in the early video. Moreover, the use of the display commands allows any of a number of SoCs 101 associated with different manufacturers to be incorporated into a particular computer platform 99 and be used in an early video solution. In this manner, an original equipment manufacturer (OEM) of the computer platform 99 may provide, for SoC manufacturers, a specification detailing the syntax of the display command. Moreover, the specification may set forth a mapping between command codes and respective early video features. In an example, a look-up table corresponding to the mapping may be represented by data that is stored in a UEFI volume, which is accessible by the early video management engine 162.

The end of the early video coincides with the host's discovery of the video display interface 110, the host's allocation of system resources for the video display interface, and the host's configuration of the video display interface 110. The end of the early video means that the host 100 may thereafter communicate with the video display interface 110 via the PCIe link 182. Responsive to the end of the early video, the host 100 may, in an example, send, via the communication link 180, a notification (called a “video takeover notification” herein) to the early video management engine 162 to notify the engine 162 that the host 100 is taking over control of the video display interface 110. Responsive to the video takeover notification, the early video management engine 162 relinquishes control of the video display interface 110. Therefore, until the host 100 powers down or is reset, the video display interface 110 is controlled by the host 100.

The duration of the early video, in accordance with example implementations, depends on how the UEFI firmware implements PCIe enumeration. In an example, during a boot of the host 100, UEFI firmware transitions through a sequence of UEFI platform initialization phases, beginning with a security, or “SEC,” phase. After the SEC phase, the UEFI firmware begins a pre-EFI, or “PEI phase,” of the platform initialization. In the PEI phase, in an example, the UEFI firmware initializes OEM hardware of the host 100, such as the main CPU cores 102 and the system memory 104. In an example, the UEFI firmware, in the PEI phase, performs PCIe enumeration that results in the discovery of the video display interface 110, the configuration of the video display interface and the allocation of system resources for the video display interface 110. In an example, the PCI enumeration in the PEI phase may be restricted in scope, such as a scope that is limited to discovering the video display interface 110. In an example, the PCIe enumeration may be limited to the PCIe root port 177, which is dedicated for the video display interface 110.

The PEI phase is proceeded by a subsequent, driver execution environment, or “DXE,” phase of the UEFI platform initialization. In the DXE phase, the UEFI firmware, among other actions, completes initialization of the computer platform hardware, executes option read only memory (ROM) firmware drivers and sets up UEFI runtime services for the post boot environment. In an example, in the DXE phase, the UEFI firmware performs PCIe enumeration for purposes of discovering PCIe endpoint devices. In an example, for implementations in which the UEFI firmware performs limited PCIe enumeration in the PEI phase to discover the video display interface 110, the UEFI firmware performs PCIe enumeration in the DXE phase to discover the remaining PCIe endpoint devices of the computer platform 99. In another example, the UEFI firmware does not perform any PCIe enumeration in the PEI phase, and the UEFI firmware performs PCIe enumeration solely in the DXE phase for purposes of discovering all PCIe endpoint devices of the computer platform 99, including the video display interface 110.

The computer platform 99, in accordance with example implementations, is a modular unit, which includes a frame, or chassis; and the modular unit includes hardware that is mounted to the chassis and is capable of executing machine-readable instructions (e.g., software and/or firmware instructions). In examples, the computer platform 99 is a server, such as a blade server, a rack server or a tower server. In other examples, the computer platform 99 may be a device other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device.

In the context that is used herein, a “video display interface” generally refers to a subsystem of a computer platform, which provides a collection of video output signals (e.g., digital signals, analog signals or a combination of digital and analog signals) that, when received by a display device, such as a monitor or a television, cause the display device to display a video. As depicted in FIG. 1, the video display interface 110 provides a video output 117 corresponding to video output signals. Although not depicted in FIG. 1, the computer platform 99 includes a connector to electrically and mechanically mate with a display cable for purposes of routing the video output 117 to a display device. In an example, the video display interface 110 is external to the BMC 129 and is powered by main power provided by the main power supply 183. In another example, the video display interface 110 is part of the BMC 129 and is powered by auxiliary power provided by the auxiliary power supply 184.

The video display interface 110 may have any of a number of architectures. In an example, the video display interface 110 is Video Graphics Array (VGA)-compliant. In this manner, the video display interface 110 is constructed to convert digital video input data into analog video signals (the video output 117 for this example) that correspond to the VGA standard. The analog video signals, for this example, correspond to the terminals, or pins, of a VGA connector (e.g., a female DE-15 connector, for example). In the context that is used herein, the “VGA standard” refers to the original VGA standard that was introduced in 1987, as well as variants from the original VGA standard, such as, Super VGA (SVGA) standard, the XGA standard and so forth. In another example, the video display interface 110 provides a Digital Visual Interface (DVI)-compliant video output 117, which includes a collection of signals corresponding to a digital video output and a collection of signals corresponding to an analog video output. In other examples, the video display interface 110 solely provides a digital video output 117, such as a High-Definition Multimedia Interface (HDMI)-compliant video output, a DisplayPort-compliant video output, or a digital video output 117 that complies with another standard.

In the context that is used herein, an “in-band communication channel” refers to the main, or primary, pathway used by a host to communicate with a component (e.g., the video display interface 110). In an example, the in-band communication channel for the video display interface 110 includes a PCIe root complex (which has an associated PCIe root port 177), the PCIe link 182 and a PCIe endpoint interface 158 of the video display interface 110. In another example, an in-band communication channel for the video display interface 110 includes a PCIe switch. In another example, an in-band communication channel for the video display interface 110 includes a non-PCIe link that is subject to complex configuration before the link can be used.

In the context that is used herein, an “out-of-band communication channel” refers to a pathway to communicate with a component, which is an alternate, or is secondary, to the component's in-band communication channel. The host 100 may not be able to access a component using the component's out-of-band communication channel, and in accordance with example implementations, the host 100 cannot access the video display interface 110 using the video display interface's out-of-band communication channel 189.

In the context that is used herein, a “host” refers to a collection of components of a computer platform, which have an unabstracted view of resources of the computer platform 99. These resources support (or “host”) one or multiple application operating environments in which application workloads execute. In examples, an application operating environment may be a virtual machine, a container, a container pod, an orchestrated container cluster, a bare-metal environment, a combination of the foregoing or any other ecosystem that supports the execution of application workloads. An application workload may be an application process or a collection of application processes that operate under the same identity.

In accordance with example implementations, the host 100 is part of a PCBA, such as an HPM, of the computer platform 99; and the BMC 129 is part of a separate PCBA of the computer platform 99. In an example, in accordance with some implementations, the BMC 129 is part of a Datacenter-ready Secure Control Module (DC-SCM) and the DC-SCM connects to an HPM (e.g., an HPM containing the host 100 and the video display interface 110) through a Datacenter-ready Secure Control Interface (DC-SCI).

For the computer platform 99, the host 100 may have an unabstracted view of main CPU cores 102, a system memory 104, an operating system, as well as other resources of the computer platform 99. After a successful boot, the host 100 operates under control of the operating system independently of the BMC 129. In accordance with some implementations, the computer platform 99 may contain multiple hosts 100. The BMC 129 manages each host 100, and this management includes, in accordance with example implementations, the BMC 129 providing management services and security services for the host 100.

The BMC 129, in accordance with example implementations, has a management plane and a security plane. The management plane includes one or multiple main management processing cores 154 that execute a set of firmware instructions, called a “firmware management stack” (also called a “BMC firmware management stack or a “BMC management stack”) for purposes of performing a variety of management services for host(s) 100 of the computer platform 99.

As examples, the BMC 129 provides such management services as operating system runtime services; resource detection and initialization; and pre-operating system services. Some management services may be remotely-managed. As examples, remotely-managed management services include keyboard video mouse (KVM) services; virtual power services (e.g., remotely-activated services to remotely set a power state of a host 100, such as a power conservation state, a power on, a reset state or a power off state); and virtual media management services.

The BMC 129 provides security services as part of its security plane. In examples, the security services may include firmware validation; managing the storage of cryptographic artifacts (e.g., certificates, seeds, cryptographic keys; measurements; and passwords) for the host(s) 100; encryption; decryption; tamper detection; random number generation; pseudorandom number generation; hash generation, measurement signing; and/or other security-related operations.

In accordance with example implementations, the BMC's security plane includes a secure enclave 140. In another example, the BMC 129 does not include a secure enclave 140. In this context, a “secure enclave” refers to a subsystem for which access into and out of the subsystem is tightly controlled. In accordance with example implementations, the secure enclave 140 is fully contained inside a cryptographic boundary. A “cryptographic boundary,” in this context, refers to a continuous boundary, or perimeter, which contains the logical and physical components of a cryptographic subsystem, such as BMC components that form the secure enclave 140. The secure enclave 140, in accordance with example implementations, is isolated from the BMC's management plane, and the secure enclave 140 is isolated from other non-secure components of the BMC 129, which are outside of the secure enclave 140.

The secure enclave 140 includes a security processor 142 (e.g., a collection of one or multiple processing cores, such as one or multiple CPU cores). The security processor 142 executes firmware instructions to provide at least some of the BMC's security services. The secure enclave 140 may also include dedicated hardware components to provide other security services for the BMC 129, such as cryptographic accelerators, a random number generator (RNG), a deterministic random number generator (DRNG), a cryptographic hash generator, a tamper detection engine and so forth.

In accordance with example implementations, the secure enclave 140 includes a silicon root of trust (SRoT) engine 143, which is a hardware-based trust anchor for the computer platform 99. Responsive to receiving auxiliary power from the auxiliary power supply 184, the SRoT engine 143 controls reset logic (not shown) to hold the security processor 142 and the main management processing cores 154 in reset. Moreover, the SRoT engine 143 controls the reset logic to hold the main CPU cores 102 in reset when the main CPU cores 102 receive main power. The SRoT engine 143 releases the security processor 142 from reset responsive to successful validation of an initial portion of the firmware 168. As part of the validation, the SRoT engine 143 loads the initial portion of the firmware 168 into a volatile memory 151 of the secure enclave 140. Moreover, in accordance with example implementations, the SRoT engine 143 locks the volatile memory 151 to prevent modification or tampering with the initial portion of the firmware 168 as the content is loaded into the volatile memory 151.

The SRoT engine 143 compares a measurement (e.g., a cryptographic hash) of the initial portion of the firmware 168 against an immutable expected value that is stored in the secure enclave 140 for purposes of validating the initial portion. If the measurement and expected values are the same, then the initial portion of the firmware 168 passes validation. Responsive to the initial portion of the firmware 168 passing validation, the SRoT engine 143 releases the security processor 142 from reset to allow the security processor 142 to boot and execute the firmware instructions that have been loaded into the volatile memory 151.

By executing the firmware instructions, the security processor 142 may then validate another portion of the firmware 168 that corresponds to a portion of the BMC's management firmware stack and after successful validation, load this portion of the management firmware stack into a volatile memory 155 of the BMC 129. In accordance with some implementations, the loading of this portion of the management firmware stack may occur concurrently with the validation of the portion. After successful validation of this other portion of the firmware 168, the SRoT engine 143 releases the BMC's main management processing core(s) 154 from reset. Responsive to being released from reset, the main management processing core(s) 154 execute the loaded portion of the firmware management stack, which causes the main management processing core(s) 154 to load additional portions of the firmware 168 and place the loaded portions into a volatile memory 164. Access to the volatile memory 164 may involve additional training and initialization steps (e.g., training and initialization steps set forth by the DDR4 specification). Those instructions may be executed from the validated portion of the BMC's firmware management stack in the volatile memory 155.

Therefore, in accordance with example implementations, a cryptographic chain of trust, which is anchored by the SRoT engine 143, may be extended from the SRoT engine 143, the hardware trust anchor, to the firmware management stack that is executed by the BMC's main processing cores 154. Moreover, when a host power on request is received, and the host 100 boots, the chain of trust is extended to host system firmware.

In accordance with example implementations, the BMC 129 is constructed to prevent a given domain or entity of the BMC 129 from powering up or coming out of reset until the secure enclave 140 validates the domain/entity. Moreover, in accordance with example implementations, the BMC 129 may prevent components of the BMC 129 from accessing resources of the BMC 129 and resources of the computer platform 99 until the secure enclave 140 approves or validates the resources. The BMC 129 may perform bus filtering and monitoring to prevent unwanted access to bus devices.

In accordance with example implementations, for purposes of performing its management and security services, the BMC 129 may communicate with a remote management server 190 via a NIC 160 of the BMC 129. As depicted in FIG. 1, the NIC 160 and the remote management server 190 are connected to network fabric 161. In accordance with example implementations, the network fabric 161 may be associated with one or multiple types of communication networks, such as CXL fabric, dedicated management networks, local area networks (LANs), wide area networks (WANs), global networks (e.g., the Internet), wireless networks, or any combination thereof.

In accordance with further implementations, the BMC 129 is connected to the network fabric 161 via a NIC expansion card, or NIC adapter, of the host 100. For example, in accordance with some implementations, the computer platform 99 includes a card edge connector (not shown) that is constructed to receive a NIC adapter that has a host interface (e.g., a PCIe interface) and a sideband channel bus interface. The NIC adapter has one or multiple ports that are connected to the network fabric 161. A sideband channel bus (not shown) of the computer platform 99 connects the BMC 129 to the sideband channel bus interface and allows the BMC 129 to use the NIC adapter for purposes of communicating with the remote management server 190. In an example the sideband channel bus corresponds to the Network Controller Sideband Interface (NC-SI) electrical interface and protocol that are defined by the Distributed Management Task Force (DMTF).

For the example implementation that is depicted in FIG. 1, the BMC 129 is part of a semiconductor package 157. Depending on the particular implementation, the semiconductor package 157 may contain one or multiple dies on which the BMC's components (e.g., the secure enclave 140, the management processing cores 154, the volatile memory 155, the early video management engine 162, and so forth) are fabricated. The semiconductor package 157 may have one of many different forms. In an example, a semiconductor package 157 contains multiple dies that are mounted on a PCB substrate that interconnects the dies. In another example, a semiconductor package 157 contains multiple dies that are interconnected by bonding wires. In an example, a semiconductor package is encapsulated. In another example, a semiconductor package 157 is not encapsulated. In other examples, a semiconductor package 157 may correspond to any of a number of different containers, such as a surface mount package, a through-hole package, a ball-grid array package, a small outline package or a chip-scale package. Regardless of its particular form, in accordance with example implementations, the semiconductor package 157 operatively electrically couples its components to a PCBA of the computer platform 99. In an example, the PCBA is a motherboard of the computer platform 99. In another example, the PCBA corresponds to a DC-SCM.

In accordance with example implementations and as depicted in FIG. 1, the video display interface 110 is a standalone component (or a standalone collection of components) external to the BMC 129. In an example, the PCIe endpoint interface 158, the video controller 111 and the video memory 113 are external to the BMC's semiconductor package 157. For these example implementations, the components of the video display interface 110 may be powered by main power that is provided by the main power supply 183. In an example, the components of the video display interface 110, except for the video memory 113, corresponds to a semiconductor package that is mounted to a motherboard of the computer platform 99. In another example, the video display interface 110 is part of a PCBA corresponding to an HPM or DC-SCM. In another example, the video display interface 110 corresponds to a removable adapter card that is installed in an expansion connector slot of the computer platform 99.

In accordance with further example implementations, the BMC 129 contains at least some components of the video display interface 110. For these example implementations, the components of the video display interface 110 may be powered by the auxiliary power supply 184. In an example, components of the video display interface 110, such as the video controller 111 and the PCIe endpoint interface 158, are contained in the BMC's semiconductor package 157. In an example, the video controller 111 and the PCIe endpoint interface 158 are fabricated in one or multiple dies of the semiconductor package 157. In an example, the PCIe endpoint interface 158 corresponds to one of the communication interfaces 156. In an example, the video memory 113 corresponds to a region of the volatile memory 164 or another memory associated with the BMC 129.

As used herein, an “engine,” such as the early video management engine 162, the SoC initialization engine 107 and any other engines that are described herein, can refer to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. In a more specific example, the BMC firmware management stack includes firmware instructions that, when executed by one or multiple main management processing cores 154 of the BMC 129, cause the BMC 129 to provide the early video management engine 162. In another example, a service processor of the SoC 101 executes embedded firmware instructions, which cause the SoC 101 to provide the SoC initialization engine 107. An “engine” can refer to a combination of one or more hardware processing circuits and machine-readable instructions (software and/or firmware) executable on the one or more hardware processing circuits. In other examples, the early video management engine 162 can be formed in whole or in part by a CPLD, a PLD, an ASIC, an FPGA or other hardware.

In general, the memory devices that form the system memory 104, the volatile memory 151, the volatile memory 155, the volatile memory 164, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

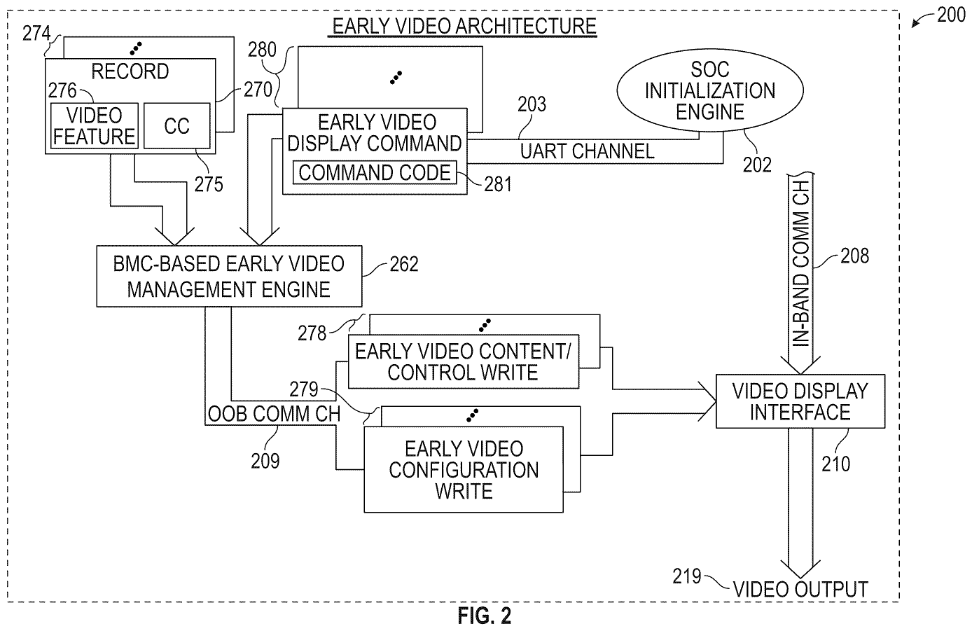

FIG. 2 depicts an early video architecture 200 for a computer platform (e.g., the computer platform 99 of FIG. 1) in accordance with example implementations. Referring to FIG. 2, the early video architecture 200 includes a video display interface 210, a BMC-based early video management engine 262 and an SoC initialization engine 202. The SoC initialization engine 202 is associated with a host of the computer platform. In an example, the SoC initialization engine 202 performs initialization operations for an SoC and for other components of the computer platform prior to the execution of system firmware. Although not depicted in FIG. 2, another early video content generator, such as, for example, system firmware, may take advantage of the early video architecture 200 for purposes of producing early video prior to host takeover of the video display interface 210. The video display interface 110, the SoC initialization engine 107 and the early video management engine 162 of FIG. 1 are examples of the video display interface 210, the SoC initialization engine 202 and the BMC-based early video management engine 262, respectively.

The video display interface 210 provides a collection of signals forming a video output 219. The video output 219, when received by a display device, causes the display device to display a video for the computer platform. The video display interface 210 is connected to an in-band communication channel 208 (e.g., a PCIe link, such as the PCIe link 182 of FIG. 1), which undergoes complex configuration during a host boot. The in-band communication channel 208 is used by the host to control and communicate with the video display interface 210 after the host executes system firmware to first configure the in-band communication channel 208 and thereafter, discover the video display interface 210.

The BMC-based early video management engine 262, responsive to the initiation of a host boot, prepares, or configures, the video display interface 210 to be controlled by the engine 262. For this purpose, the BMC-based early video management engine 262, as depicted at 279, writes to the video display interface 210 using an out-of-band communication channel 209. In an example, the configuration includes the early video management engine 262 writing to a configuration register of the video display interface 210 via the out-of-band communication channel 209.

During a host boot, the SoC initialization engine 202 determines video features to be included in the video output 219. The SoC initialization engine 202 relies on the BMC-based early video management engine 262 to generate the corresponding early video. More specifically, via the UART-based communication channel 203, the SoC initialization engine 202 sends, to the BMC-based early video management engine 262, display commands 280 for purposes of instructing the engine 262 to include certain features in the early video. Each display command 280, in accordance with example implementations, includes a corresponding command code 281. In an example, a command code 281 identifies a particular early video feature for the early video.

The BMC-based early video management engine 262, in accordance with example implementations, converts a command code 281 into a corresponding early video feature. For this purpose, the BMC-based early video management engine 262 accesses the look-up table 270. The look-up table 270, in accordance with example implementations, contains mapping records 274. Each mapping record 274 is associated with a particular command code 281. Accordingly, the BMC-based early video management engine 262 uses the command code 281 of a display command 280 as an index to identify the appropriate mapping record 274. The mapping record 274 contains data 275 identifying the associated command code 281, and the mapping record 274 contains data 276 identifying or representing an early video feature to which the associated command code 281 is mapped. In examples, the data 276 directly represents an image, a text character, a collection of text characters, a progress bar, a progress bar status, logo, a user option menu, a status, or other early video feature. In another example, the data 276 represents a pointer or other identifier that the BMC-based early video management engine 282 uses to identify the early video feature. In another example, the data 276 represents or identifies an organization or an effect (e.g., scrolling, a flashing effect or element rearrangement) for the early video.

After identifying the early video feature corresponding to a particular command code 281, the BMC-based early video management engine 262, as depicted at 278, initiates one or multiple writes to the video display interface 210 using the out-of-band communication channel 209. In examples, a particular write 278 may be directed to writing video content to a display memory (e.g., a frame buffer) of the video display interface 210 or writing to a control register of a video controller of the video display interface 210. Moreover, controlling the video display interface 210 may include the BMC-based early video management engine 262 reading from the video display interface 210 via the out-of-band communication channel 209. In another example, controlling the video display interface 210 to include the early video feature may include the BMC-based early video management engine 262 performing, via the out-of-band communication channel 209, a combination of one or multiple reads from the video display interface 210 and one or multiple writes to the video display interface 210.

The host, as part of platform initialization operations, eventually discovers endpoint devices that are connected to in-band communication channels that are subject to training (such as the in-band communication channel 208), which results in the host's discovery of the video display interface 210. In an example, the in-band communication channel 208 is a PCIe link. Through PCIe enumeration, the UEFI firmware discovers the video display interface 210. Responsive to discovering the video display interface 210, configuring the video display interface 210 and allocating system resources for the video display interface 210, the host takes over control of the video display interface 210.

The video display interface 210 is a shared resource in that the video display interface 210 is shared between the host and the BMC (although at different times). Synchronizing access to the video display interface 210 may occur in any one of a number of different ways. In an example, the synchronization includes the UEFI firmware sending (e.g., sending via the UART-based communication channel 203) a video takeover notification to the BMC-based early video management engine 262 to notify the engine 262 that the host is taking over control of the video display interface 210. The video takeover notification coincides to the end of early video generation and the beginning of video generation using communications that occur over the in-band communication channel 208. The BMC-based early management engine 262 therefore ceases using the video display interface 210 in response to receiving the video takeover notification.

In another example, the UEFI firmware does not send a video takeover notification to notify the BMC-based early video management engine 262 about the host's takeover of the video display interface 210, but instead, the UEFI firmware blocks, or prevents, the BMC-based early video management engine 262 from controlling the video display interface 210. For example, responsive to the host taking over control of the video display interface 210, the synchronization includes the UEFI firmware configuring the video display interface 210 so that registers of the video display interface 210 are “read only” to the BMC (thereby preventing the BMC-based early video management engine 262 from controlling or using the video display interface 210).

FIG. 3 is a block diagram of a communication channel architecture 300 for a computer platform (e.g., the computer platform 99 of FIG. 1) in accordance with example implementations. The architecture 300 includes a BMC 329 and a video display interface 310. The BMC 329 includes one or multiple management processing cores 354 and a memory 355. For this example implementation, one or multiple management processing cores 354 execute hardware processor-readable instructions 356 that are stored in the memory 355 for purposes of forming an early video management engine 370. The BMC 129, the early video management engine 162, the video display interface 110, the management processing cores 154 and the volatile memory 164 of FIG. 1 are examples of the BMC 329, the early video management engine 370, the video display interface 310, the management processing cores 354 and the memory 355, respectively.

The early video management engine 370 communicates with the video display interface 310 using an out-of-band communication channel 302. The out-of-band communication channel 302 includes a system bus 320 and an out-of-band decode engine 330 of the BMC 329. The out-of-band communication channel 302 relies on a BMC memory address space 356, which is the memory address space that is viewed by the BMC's main management processing cores 354. As depicted in FIG. 3, the BMC memory address space 356 includes an address subspace 360 (referred to as a video display interface subspace 360 in FIG. 3) that contains BMC memory addresses that correspond to (or are “mapped to”) address spaces of the video display interface 310. In an example, the address subspace 360 includes addresses 362 that correspond to a configuration address space of the video display interface 310. In another example, the address subspace 360 includes addresses 363 that correspond to an I/O address space of the video display interface 310. In another example, the address subspace 360 includes addresses 364 that correspond to a memory address space of the video display interface 310.

Configuration, I/O and memory addresses of the video display interface 310 therefore appear, to the main management processing cores 354, to be within the BMC memory address space. An address decoder 380 (e.g., logic inside a bridge) of the BMC 329 directs transactions (e.g., read and write transactions) on the system bus 320 to the appropriate peripheral destinations based on the addresses of the transactions. The out-of-band decode engine 330 is part of the address decoder 380 and is constructed to direct system bus 320 transactions that target addresses within the address subspace 360 to the appropriate video display interface 310 resources (e.g., registers 308, video memory 307 and I/O ports). For this purpose, the out-of-band decode engine 330, directs a system bus transaction that targets a particular address corresponding to a video display interface resource to an interconnect 333 that is connected to the resource. The communication channel architecture 300 may have multiple interconnects 333.

In an example, a video controller of the video display interface 310 is part of the BMC 329. In an example, a main management processing core 354 may generate a transaction on the system bus 320 targeting an address 362 that corresponds to a configuration space register 308 for such purposes as initializing or configuring the video display interface 310. The out-of-band decode engine 330 recognizes the address 362 and directs the transaction to an interconnect 333 that is connected to the configuration space register 308. For this example, the interconnect 333 may include a collection of data, address and control lines. In another example, a main management processing core 354 may generate a transaction on the system bus 320 targeting an address 363 that corresponds to an I/O space register 308 for such purposes as controlling a video effect. The out-of-band decode engine 330 recognizes the address 363 and directs the transaction to an interconnect 333 that is connected to the I/O space register 308.

In another example, the video display interface 310 corresponds to a standalone component that is not part of the BMC 329. In an example, a main management processing core 354 may generate a transaction on the system bus 320 targeting an address 362 that corresponds to a configuration space I/O port of the video display interface 310 for such purposes as initializing or configuring the video display interface 310. The out-of-band decode engine 330 recognizes the address 362 and directs the transaction to an interconnect 333 that is connected to the configuration space I/O port. For this example, interconnect 333 may be a peripheral bus (e.g., an I2C bus, an I3C bus, a SPI bus, an eSPI bus, an SMBus, an Advanced High-performance Bus (AHB), an Advanced eXtensible Interface (AXI) bus, or other peripheral bus). In another example, a main management processing core 354 may generate a transaction on the system bus 320 targeting an address 363 that corresponds to an I/O space I/O port of the video display interface 310 for such purposes as controlling a video effect. The out-of-band decode engine 330 recognizes the address 363 and directs the transaction to an interconnect 333 that is connected to the I/O space I/O port.

In another example, a main management processing core 354 may generate a transaction on the system bus 320 targeting a frame buffer address 364 associated with the video display interface 310. In an example, a video controller of the video display interface 310 is part of the BMC 329, and a frame buffer associated with the video display interface 310 corresponds to a designated part of the memory 355. The out-of-band decode engine 330 recognizes the frame buffer address 364 and directs the transaction to the designated part of the memory 355. In another example, the video controller is not part of the BMC 329, and the out-of-band decode engine 330 directs the transaction to an interconnect 333 for a memory corresponding to the frame buffer.

As also depicted in FIG. 3, the video display interface 310 is connected to an in-band communication channel 303. For the depicted example implementation, the in-band communication channel 303 includes a PCIe interface 388 of the video display interface 310 and a PCIe link 389 that connects the PCIe interface 388 to a PCIe root complex of the computer platform.

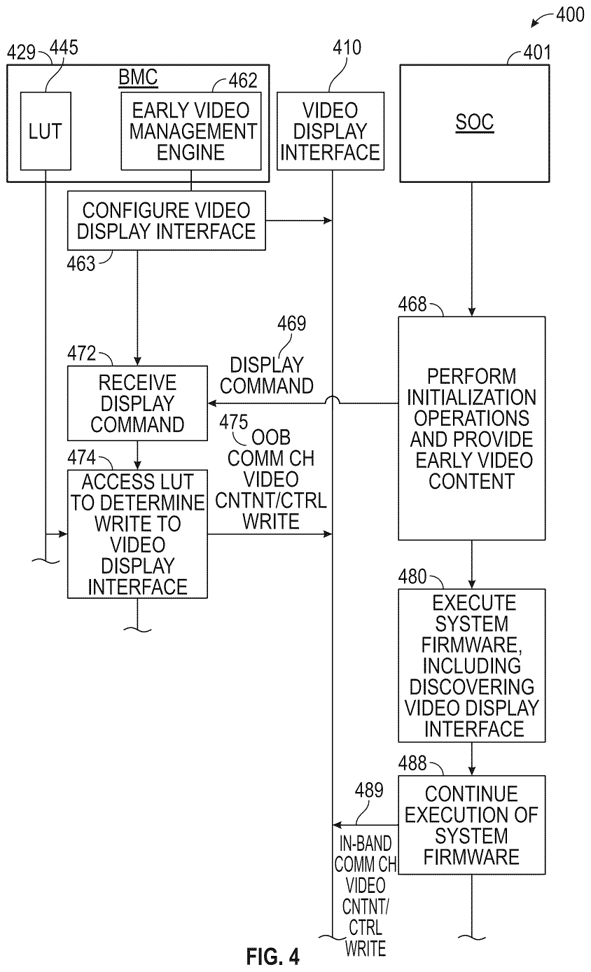

FIG. 4 is a sequence flow diagram 400 illustrating communications of and actions taken by components of an early video solution to generate early video for SoC initialization operations, in accordance with example implementations. Referring to FIG. 4, the sequence 400 is initiated in response to a host power on request. It is assumed that a video display interface 410 and power consuming components of a host are powered up at the beginning of the sequence. Moreover, it is assumed that a BMC 429 of the computer platform is powered by auxiliary power.

FIG. 4 depicts the video display interface 410 as being external to the BMC 429. For these implementations, the video display interface 410 may, in an example, be powered by the main power supply of the computer platform. In accordance with further implementations, components (e.g., all components of the video display interface 410 except for a video memory) of the video display interface 410 may be located inside the BMC 429, and in an example, all of the components of the video display interface 410 are powered by auxiliary power.

The video display interface 410 is connected to an SoC 401 of a host by an in-band communication channel that is subject to a complex configuration. As such, without an early video management engine 462 of the BMC 429, early video for SoC initialization operations would be unavailable. For purposes of generating early video, the early video management engine 462 controls the video display interface via an out-of-band communication channel.

The SoC 101 of FIG. 1 is an example of the SoC 401 of FIG. 4. The BMC 429 manages the host. Among its other features, the BMC 429 has access to a look-up table 445. The BMC 129, the video display interface 110 and the early video management engine 162 of FIG. 1 are examples of the BMC 429, the video display interface 410 and the early video management engine 462, respectively.

Responsive to a host power on request, the early video management engine 462, as depicted at 463, configures the video display interface 410 for early video. In an example, the host power on request is initiated in response to a power button of the computer platform being depressed. In another example, the host power on request is initiated by the BMC 429 (e.g., initiated by the BMC 429 in response to the power on being remotely initiated as part of the BMC's remote power management service). In accordance with example implementations, the configuration allows the video output of the video display interface 410 be controlled by the early video management engine 462.

In an example, the BMC 429 masks a reset signal to the video display interface 410, which allows the BMC 429 to use the video display interface 410 before the video display interface 410 is otherwise available. Reset logic of the computer platform is configured to assert the reset terminal of the video display interface 410 (to correspondingly hold the video display interface 410 in reset) when the in-band communication channel for the video display interface 410 is in reset. The BMC 429, in accordance with example implementations, has a configuration register that contains a video reset mask bit. The BMC 429 has logic that is constructed to gate the reset signal based on the state of the video reset mask bit. This mechanism allows the BMC 429 to de-assert the reset signal (and therefore, release the video display interface 410 from reset) when the reset signal would have otherwise been asserted by the computer platform. In an example, the early video management engine 462 writes to the configuration register to place the video reset mask bit in a state that masks the reset signal and allows the video display interface 410 to come out of reset and be used by the early video management engine 462. In an example, the video display interface 410 is powered by auxiliary power, and the video reset mask bit allows the BMC 429 to use the video display interface 410 even if the host is powered off. In another example, the video display interface 410 is powered by main power, and the video reset mask bit allows the BMC 429 to use the video display interface 410 independently from the state of the host's power up sequence (i.e., allows the BMC 429 to use the video display interface 410 even though the in-band communication channel is still in reset).

As depicted at 468, the SoC 401 performs SoC initialization operations. In examples, the SoC initialization operations may include an operation to initialize a system memory interface of the SoC 401. In another example, an SoC initialization operation initializes a storage interface of the SoC 401. In another example, an SoC initialization operation initializes a network interface of the SoC. In another example, an SoC operation initializes a service processor of the SoC 401. During SoC initialization operations, as also depicted at 468, the SoC 401 determines video features (or “early video content items”) to be included in the early video. The video features may include messages, progress bars, reporting of error events, displaying UEFI initialization progress, images, logos, a guide for user-selectable boot options, a scrolling effect, a flashing effect, as well as other video features.

FIG. 4 depicts an exemplary communication between the SoC 401 and the early video management engine 462 for purposes of including a particular video feature in the early video. As depicted at 468, as a result of the SoC initialization operations, the SoC 401 sends a display command 469 to the early video management engine 462. In an example, the SoC 401 sends the display command 469 to the early video management engine 462 via a UART communication channel between the SoC 401 and the BMC 429.

In an example, the display command 469 is a unit of data that represents a string of characters, and a prefix of the string identifies the string as corresponds to a particular command code, which is represented by the remaining part of the string. In accordance with example implementations, the SoC 401 matches a particular early video feature with the corresponding command code, and the display command 469 includes data representing the command code.

The early video management engine 462, in accordance with example implementations, receives the display command 469, as depicted at 472. In an example, the reception of the display command 469 corresponds to the early video management engine 462 being alerted to data in the BMC's UART buffer, which represents the display command 469. In an example, the early management engine 462 examines data received in the BMC's UART buffer for purposes of determining whether the data has a certain prefix (e.g., an escape sequence) that identifies the data as representing a display command. If so, the early video management engine 462 extracts the command code from the display command.

For purposes of mapping the command code contained in the display command 469 to a particular early video feature, the early video management engine 462 accesses the look-up table 445, as depicted at 474. The look-up table 270 of FIG. 2 is an example of the look-up table 445. In accordance with further implementations, the early video management engine 462 determines the early video feature corresponding to the command code in another way. In an example, the early video management engine 462 applies a rule to the command code to derive the early video feature. In another example, the command code is self-describing (or “self-contained”) and therefore, directly indicates or represents the corresponding early video feature.

In an example, the look-up table 445 corresponds to a particular firmware volume (e.g., an UEFI volume). In an example, responsive to the BMC 429 powering up, the early video management engine 462 retrieves and stores a copy of the firmware volume in a memory of the BMC 420. The early video management engine 462 uses the look-up table 445 to identify an early video feature to which the associated command code is mapped. The early video management engine 462 then initiates, as depicted at 475, a write to the video display interface 410 to apply the early video feature to the early video. In examples, the write is a write to a display buffer of the video display interface 410 or a write to a control register of the video display interface 410. Moreover, the early video management engine 462 may initiate multiple writes to the video display interface 410 for purposes of including the video content item in the early video. Applying a particular early video feature may also involve the early video management engine 462 reading from the video display interface 410.

After SoC initialization operations are complete, a boot CPU core of the SoC 401 may then begin to execute system firmware, as depicted at 480. The execution of the system firmware, as part of the platform initialization, eventually discovers and configures endpoint devices that are connected to in-band communication channels that are subject to complex configurations, such as the in-band communication channel that is connected to the video display interface 410. In an example, the in-band communication channel connected to the video display interface 410 is a PCIe link. The system firmware performs extensive and complex operations to configure the in-band communication channel. After the in-band communication channel is configured, the system firmware performs PCIe enumeration, which results in the discovery of the video display interface 410 by the system firmware. At this point, the system firmware allocates system resources and configures the video display interface 410 based on the allocation. The system firmware may thereafter access the video display interface 410 for purposes of producing video content.

More specifically, after discovering the video display interface 410, the system firmware takes over responsibility, or control of, the video display interface 410. The system firmware continues to be executed for purposes of performing platform initialization operations, as depicted at 488. As a result of these platform initialization operations, the system firmware may identify or determine early video features of the later video. FIG. 4 depicts the system firmware, in connection with performing the platform initialization operations of block 488, initiating a write 489 to the video display interface 410 to include a particular video content item in the video. In an example, the write 489 is a write to a display buffer of the video display interface 410 or a write to a control register of the video display interface 410. Moreover, the system firmware may initiate multiple writes to the video display interface 410 for purposes of including the video content item in the video.

In accordance with example implementations, the video display interface 410 is a shared resource, and access synchronization to the video display interface 410 may use one of a number of different access synchronization techniques. For example, in accordance with some implementations, responsive to discovering the video display interface 410, the system firmware informs the early video management engine 462 that the host is taking over control of the video display interface 410 by sending a video takeover notification. Responsive to receiving the video takeover notification, the early video management engine 462 relinquishes control of the video display interface 410. In an example, the relinquishing of control of the video display interface 410 corresponds to the early video management engine 462 no longer issuing accesses (e.g., read and write accesses) to the video display interface 410 via the out-of-band communication channel.

In an example, for purposes of sending a video takeover notification, the system firmware sends, to the early video management engine 462 and via a UART communication channel, a display command containing a command code that is uniquely associated with a video takeover notification. In another example, the system firmware notifies the early video management engine 462 as to the video takeover by sending, to the engine 462 and via a UART communication channel, data representing a string of characters and having a non-command prefix that is uniquely associated with a video takeover notification.

In an example, the system firmware waits for an acknowledgment from the early video management engine 462 for the video takeover notification before the system firmware takes over control of the video display interface 410, and the system firmware may send one or multiple additional video takeover notifications (assuming no acknowledgements) before taking over control of the video display interface 410. In an example, the early video management engine 462 sends a confirmation to the system firmware via the out-of-band communication channel. In another example, the early video management engine 462 neither acknowledges the video takeover notification nor is expected by the system firmware to do so, and the host takes over control of the video display interface 410 after sending the video takeover notification.

In an example, as part of relinquishing control of the video interface controller, the early video management engine 462 configures the video display interface 410 to no longer be controlled by the engine 462. In another example, the early video management engine 462 does not perform any further writes to the video display interface 410 after receiving a takeover notification, and as such, relinquishing control of the video display interface 410 does not involve any further action by the early video management engine 462.

Access synchronization to the video display interface (a shared resource) may occur in any of a number of different ways. One example of access synchronization is the sending of a video takeover notification. In another example of access synchronization, the system firmware does not send a video takeover notification or otherwise notify the early video management engine 462 about the takeover of the video display interface 410. Instead, the system firmware configures the video display interface 410 so that registers of the video display interface 410 are “read only” to the BMC 429, thereby preventing the early video management engine 462 from thereafter controlling the video display interface 410.

In the context that is used herein, a BMC is a specialized service processor that monitors the physical state of a server or other hardware using sensors and communicates with a management system through a management network. The BMC may also communicate with applications executing at the operating system level through an input/output controller (IOCTL) interface driver, a representational state transfer (REST) application program interface (API), or some other system software proxy that facilitates communication between the BMC and applications. The BMC may have hardware level access to hardware devices that are located in a server chassis including system memory. The BMC may be able to directly modify the hardware devices. The BMC may operate independently of the operating system of the system in which the BMC is disposed. A BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, BMC has management capabilities for sub-systems of a computing device, and is separate from a processing resource that executes an operating system of a computing device. The BMC is separate from a processor, such as a central processing unit, which executes a high-level operating system or hypervisor on a system.

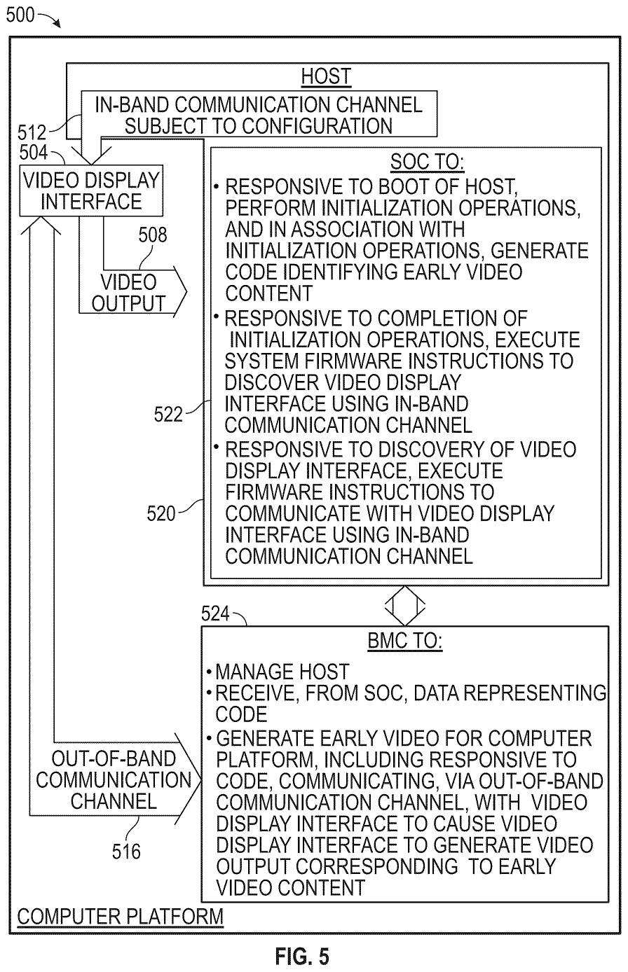

Referring to FIG. 5, in accordance with example implementations, a computer platform 500 includes an out-of-band communication channel 516; a video display interface 504; a host 520; and a BMC 524. In an example, the computer platform 500 is a server, such as a blade server, a rack server or a tower server. In other examples, the computer platform 500 is a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device. In an example, the computer platform 500 includes an SoC. In an example, the host 520 corresponds to a HPM, and the BMC 524 corresponds to a DC-SCM. In an example, the video display interface 504 is part of a HPM.

In an example, the video display interface 504 provides a video output that is a collection of analog video output signals. In an example, the video output is VGA-compliant. In another example, the video output is a collection of digital video output signals. In another example, the video output is a collection of analog and digital video output signals.

The video display interface 504 is coupled to the out-of-band communication channel 516. In an example, the out-of-band communication channel 516 includes an internal bus of the BMC 524. In an example, the out-of-band communication channel 516 includes a system bus of the BMC 524. In an example, the out-of-band communication channel 516 is associated with a mapping of a video display memory of the video display interface 504 to a memory address space of the BMC 524. In an example, the out-of-band communication channel 516 is associated with a mapping of a register of the video display interface 504 to an I/O address space of the BMC 524. In an example, the out-of-band communication channel 516 is associated with a mapping of a register of the video display interface 504 to an MMIO address space of the BMC 524. In an example, the out-of-band communication channel 516 includes an I/O bus. In examples, the out-of-band communication channel 516 includes an I2C bus, an I3C bus, a SPI bus, an eSPI bus or an SMB.

The host 520 includes an in-band communication channel 512 and a server-on-a-chip (SoC) 522. The in-band communication channel 512 is subject to a configuration. In an example, the in-band communication channel 512 is a PCIe link, which is not available in the initial part of a boot until the corresponding PCIe root complex is initialized and configured. In examples, the initialization and configuration of the PCIe root complex may involve, among other operations, PCIe link training to establish PCIe link parameters (e.g., data rates and equalization parameters); selecting whether particular PCIe lanes use PCIe or CXL protocols; selecting lane groupings, selecting lane widths; and selecting link supply voltages.

In an example, the SoC 522 includes CPU cores and a system memory interface. In an example, SoC 522 includes a storage interface. In an example, the SoC includes a network interface. In an example, the SoC includes a single die. In another example, the SoC includes multiple dies. In an example, the SoC includes one or multiple service processors. An RAS processor is an example of a service processor. A management engine is another example of a service processor.

The SoC 522, responsive to the boot, performs initialization operations, and in association with initialization operations, generates a code that identifies an early video content. In an example, a code corresponds to data that represents a string of characters, and a prefix of the string represents an escape sequence. In an example, the code corresponds to a progress bar. In another example, the code corresponds to a progress bar update percentage. In another example, the code corresponds to a message. In another example, the code corresponds to an icon. In another example, the code corresponds to an image. In another example, the code corresponds to a logo. In another example, the code corresponds to a single character. In another example, the code corresponds to multiple characters. In another example, the code corresponds to an effect to apply to the early video.

The SoC 522, responsive to completion of the initialization operations, executes firmware instructions to discover the video display interface using the in-band communication channel. The SoC 522, responsive to the discovery of the video display interface, executes firmware instructions to communicate with the video display interface using the in-band communication channel.

The BMC 524 manages the host 520. In an example, the BMC 524 managing the host 520 includes the BMC 524 providing one or multiple management services for the host 520 in association with the BMC's management plane. In examples, the BMC 524 provides such management services as operating system runtime services; resource detection and initialization; and pre-operating system services. Some management services may be remotely-managed. As examples, remotely-managed management services include KVM services; virtual power services; and virtual media management services.

In an example, the BMC 524 managing the host 520 includes the BMC 524 providing one or multiple security services for the host 520 in connection with the BMC's security plane. In examples, the security services may include firmware validation; managing the storage of cryptographic artifacts (e.g., certificates, seeds, cryptographic keys; measurements; and passwords) for the host 100; encryption; decryption; tamper detection; random number generation; pseudorandom number generation; hash generation, measurement signing; among other security-related operations.

The BMC 524 receives, from the SoC 522, data representing the code. The BMC 524 generates an early video for the computer platform 500. Generating the early video includes, responsive to the code, communicating, via the out-of-band communication channel, with the video display interface to cause the video display interface to cause the video display interface to generate a video output that corresponds to the early video content.

In an example, generating the early video includes, responsive to the boot of the host and prior to discovery of the video display interface 504 by the host 520, communicating, via the out-of-band communication channel 516, with the video display interface 504 to control the video output 508. In an example, for purposes of generating the early video, the host 520 communicates with the BMC 524 via a UART-based communication channel.

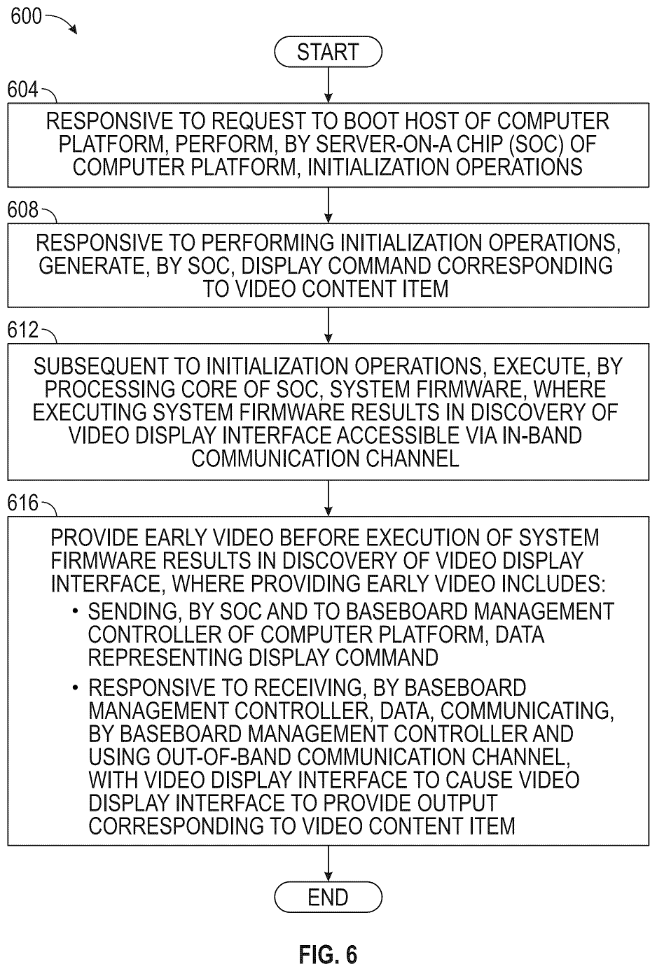

Referring to FIG. 6, in accordance with example implementations, a technique 600 includes, responsive to a request to boot a host of a computer platform, performing (block 604), by an SoC of the computer platform, initialization operations. In an example, an initialization operation includes an initialization of a service processor of the SoC. In an example, an initialization operation initializes a system memory interface of the SoC. In another example, an initialization operation initializes a storage interface of the SoC. In another example, an SoC initialization operation initializes a network interface of the SoC. In another example, an initialization operation initializes a RAS service processor of the SoC. In another example, an initialization operation initializes a management engine of the SoC.

The technique 600 includes, responsive to performing the initialization operations, generating (block 608), by the SoC, a display command corresponding to a video content item. In an example, the display command corresponds to data that represents a string of characters, and a prefix of the string represents an escape sequence. In an example, the video content item is a progress bar. In an example, the video content item is a progress bar update percentage. In an example, the video content item is a message. In an example, the video content item is an icon. In an example, the video content item is an image. In an example, the video content item is a logo. In an example, the video content item is a single character. In an example, the video content item corresponds to multiple characters.

The method 600 includes, pursuant to block 612, subsequent to the initialization authorizations, executing, by a processing core of the SoC, system firmware. Executing the system firmware results in a discovery of a video display interface, which is accessible via an in-band communication channel. In an example, the processing core is a boot CPU core. In an example, the system firmware is UEFI firmware. In an example, the system firmware is BIOS firmware. In an example, the system firmware is Coreboot system firmware. In another example, the system firmware is a combination of UEFI firmware and Linux kernel code. In an example, discovery of the video display interface coincides with PCIe enumeration, and the in-band communication channel is a PCIe link.

The technique 600 includes, pursuant to block 616, providing early video before the execution of the system firmware results in the discovery of the video display interface. As depicted in block 616, providing the early video includes sending, by the SoC and to a BMC of the computer platform, data representing the display command. In an example, the data is a serially-communicated data sequence corresponding to a string of characters. In an example, the string includes a prefix corresponding to an escape sequence that designates the sequence as being a display command.

As also depicted in block 616, providing the early video includes, responsive to receiving, by the BMC, the data, communicating, by the BMC and using an out-of-band communication channel, with the video display interface to cause the video display interface to provide an output corresponding to the video content item.

In an example, the out-of-band communication channel includes an internal bus of the BMC. In an example, the out-of-band communication channel includes a system bus of the BMC. In an example, the out-of-band communication channel is associated with a mapping of memory, configuration and I/O address spaces of the video display interface into a memory address space of the BMC. In an example, the out-of-band communication channel includes an out-of-band decoder engine of the BMC. In an example, the out-of-band communication channel includes one or multiple interconnects. In an example, the out-of-band decoder engine is coupled to a system bus of the BMC and is further coupled to resources of the video display interface by one or multiple interconnects. In an example, an interconnect corresponds to a collection of address, data and control lines. In an example, an interconnect corresponds to a peripheral bus. In an example, an interconnect includes an I2C bus, an I3C bus, a SPI bus, an eSPI bus, an AHB or an AXI bus.

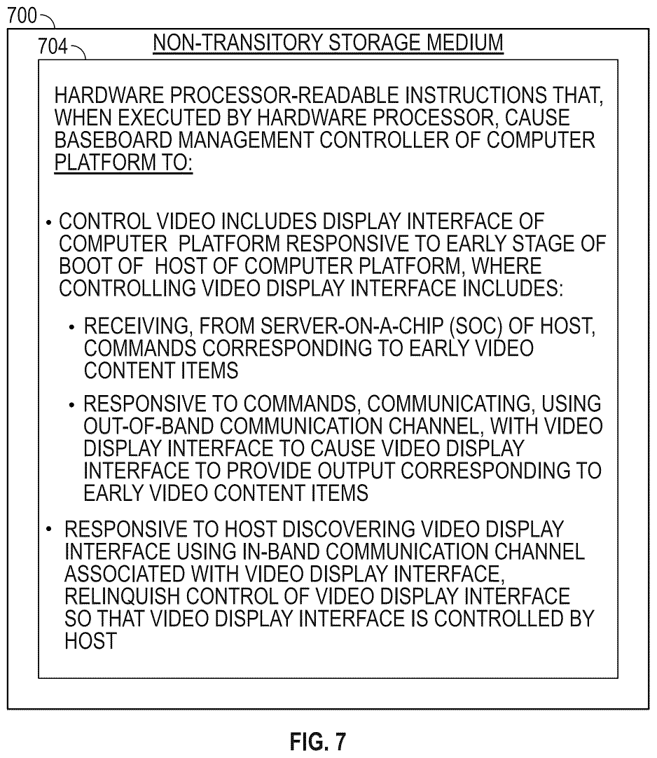

Referring to FIG. 7, in accordance with example implementations, a non-transitory storage medium 700 stores hardware processor-readable instructions 704 that, when executed by a hardware processor, cause a BMC of a computer platform to control a video display interface of the computer platform responsive to an early stage of a boot of a host of the computer platform. In an example, the storage medium 700 includes a collection of non-transitory memory devices, such as semiconductor storage devices, flash memory devices, memristors, phase change memory devices, a combination of one or more of the foregoing storage technologies, and so forth. In examples, the memory devices may be volatile memory devices (e.g., DRAM devices, SRAM) devices, and so forth) or non-volatile memory devices (e.g., flash memory devices, ROM devices and so forth). In an example, the hardware processor includes a collection of one or multiple processing cores. In an example, the hardware processor includes a collection of one or multiple CPU cores.

In an example, the BMC includes a semiconductor package that is mounted to a motherboard of the computer platform. In an example, the semiconductor package contains one or multiple dies (corresponding to respective integrated circuits) that are mounted on a PCB substrate that interconnects the dies. In another example, the semiconductor package contains multiple dies that are interconnected by bonding wires. In an example, the semiconductor package is encapsulated. In another example, the semiconductor package is not encapsulated. In other examples, the semiconductor package may correspond to any of a number of different containers, such as a surface mount package, a through-hole package, a ball-grid array package, a small outline package or a chip-scale package. In an example, the semiconductor package is mounted to a PCBA that corresponds to a DC-SCM. In another example, the semiconductor package is mounted to a motherboard of the computer platform.

In an example, the computer platform is a server, such as a blade server, a rack server or a tower server. In other examples, the computer platform is a component other than a server, such as a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based electronic device. In an example, the computer platform includes an SoC.

In an example, the video display interface provides a collection of VGA-compliant analog video output signals. In another example, the video display interface provides a collection of digital video output signals. In another example, the video display interface provides a collection of analog and digital video output signals.

The instructions 704, when executed by the hardware processor, cause the hardware processor to control a video display interface of the computer platform responsive to an early stage of a boot of a host of the computer platform. In an example, the early stage of the boot corresponds to a time period beginning when the boot begins and ending when the host discovers the video display interface. In an example, the host discovers the video display interface during PCIe enumeration.

In an example, the instructions 704 cause the BMC to configure the video display interface for out-of-band access. In an example, the configuration includes the BMC writing to a configuration register of the video display interface. In an example, the configuration includes the BMC setting the state of a mask bit to release the video display interface from reset and allow the video display interface to be used by the BMC.

Controlling the video display interface includes receiving, from an SoC of the host, commands corresponding to early video content items; and responsive to the commands, communicating, using an out-of-band communication channel, with the video display interface to cause the video display interface to provide an output corresponding to the early video content items. In an example, the out-of-band communication channel includes an internal bus of the BMC. In an example, the out-of-band communication channel includes a system bus of the BMC. In an example, the out-of-band communication channel is associated with a mapping of memory, configuration and I/O address spaces of the video display interface into a memory address space of the BMC. In an example, the out-of-band communication channel includes an out-of-band decoder engine of the BMC. In an example, the out-of-band communication channel includes one or multiple interconnects. In an example, the out-of-band decoder engine is coupled to a system bus of the BMC and is further coupled to resources of the video display interface by one or multiple interconnects. In an example, an interconnect corresponds to a collection of address, data and control lines. In an example, an interconnect corresponds to a peripheral bus. In an example, an interconnect includes an I2C bus, an I3C bus, a SPI bus, an eSPI bus, an AHB or an AXI bus.

The instructions 704, when executed by the hardware processor, further cause the hardware processor to, responsive to the host discovering the video display interface using an in-band communication channel associated with the video display interface, relinquish control of the video display interface so that the video display interface is controlled by the host. In an example, the in-band communication channel is subject to a complex configuration. In an example, the in-band communication channel is a PCIe link, which is not available in the initial part of a boot until the corresponding PCIe root complex is initialized and configured. In examples, the initialization and configuration of the PCIe root complex may involve, among other operations, PCIe link training to establish PCIe link parameters (e.g., data rates and equalization parameters); selecting whether particular PCIe lanes use PCIe or CXL protocols; selecting lane groupings, selecting lane widths; and selecting link supply voltages.

In an example, relinquishing control of the video display interface includes the BMC no longer issuing accesses to the video display interface using the out-of-band communication channel. In another example, relinquishing control of the video display interface occurs in response to the BMC receiving a takeover notification from the host. In another example, relinquishing control of the video display interface includes the host configuring the video display interface so that the BMC can no longer write to the video display interface.

In accordance with example implementations, the SoC performs the initialization operation to initialize a service processor of the SoC, and the early video content includes a status that is associated with the initialization of the service processor. Among the potential benefits, early video may reveal information that assures a user that the boot is proceeding as expected.

In accordance with example implementations, the SoC performs the initialization operation to initialize a resource interface of the SoC, and the early video content includes a status associated with the initialization of the resource interface. Among the potential benefits, early video may reveal information that assures a user that the boot is proceeding as expected.

In accordance with example implementations, the initialization operation is associated with an error, and the early video content includes a message identifying the error. Among the potential benefits, early video may reveal a boot-related issue that causes a boot to fail before the host discovers the video display interface.

In accordance with example implementations, the SoC performs the initialization operation in associated with a stage of the boot, and the early video content represents a progress corresponding to the stage. Among the potential benefits, early video may reveal information that assures a user that the boot is proceeding as expected.

In accordance with example implementations, the BMC controller, responsive to receiving the code, associates the code with data representing the video content and writes the data, via the out-of-band communication channel, to a memory that is associated with the video display interface. Among the potential benefits, early video may reveal information that assures a user that the boot is proceeding as expected.

In accordance with example implementations, the BMC accesses a look-up table corresponding to a code-to-video content mapping to identify the data associated with the code. Among the potential benefits, early video may reveal information that assures a user that the boot is proceeding as expected.

In accordance with example implementations, a first memory address space of the video display interface is mapped into a second memory address space of the baseboard management controller. The second memory address space corresponds to the out-of-band communication channel. The baseboard management controller to write to an address in the second memory address space to cause the video display interface to generate the video output. Among the potential benefits, early video may reveal information that assures a user that the boot is proceeding as expected.

In accordance with example implementations, an I/O address space of the video display interface is mapped into a subregion of a memory address space of the baseboard management controller. The subregion corresponds to the out-of-band communication channel. The baseboard management controller to write to an address in the subregion to cause the video display interface to generate the video output. Among the potential benefits, early video may reveal information that assures a user that the boot is proceeding as expected.

In accordance with example implementations, the SoC includes a root port corresponding to the in-band communication link. Among the potential benefits, early video may reveal information that assures a user that the boot is proceeding as expected.

In accordance with example implementations, the computer platform includes a serial communication channel. The serial communication channel includes a first serial communication interface of the SoC and a second serial communication interface of the BMC. The SoC to further send, to the BMC, data over the serial communication channel representing the code. Among the potential benefits, early video may reveal information that assures a user that the boot is proceeding as expected.

In accordance with example implementations, the SoC includes a semiconductor package, and the semiconductor package includes CPU cores, a memory controller interface and a service processor. Among the potential benefits, early video may reveal information that assures a user that the boot is proceeding as expected.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A computer platform comprising:
an out-of-band communication channel;
a video display interface coupled to the out-of-band communication channel;
a host comprising:
an in-band communication channel coupled to the video display interface, wherein the in-band communication channel to be configured in response to a boot of the host; and
a server-on-a-chip (SoC) to:
responsive to the boot, perform initialization operations, and in association with the initialization operations, generate a code identifying an early video content;
responsive to completion of the initialization operations, execute system firmware instructions to discover the video display interface using the in-band communication channel; and
responsive to the discovery of the video display interface, execute firmware instructions to communicate with the video display interface using the in-band communication channel; and
a baseboard management controller to:
manage the host;
receive, from the SoC, data representing the code; and
generate an early video for the computer platform, wherein generating the early video comprises responsive to the code, communicating, via the out-of-band communication channel, with the video display interface to cause the video display interface to generate a video output corresponding to the early video content.

2. The computer platform of claim 1, wherein the SoC to perform the initialization operation to initialize a service processor of the SoC, and the early video content comprises a status associated with the initialization of the service processor.

3. The computer platform of claim 1, wherein the SoC to perform the initialization operation to initialize a resource interface of the SoC, and the early video content comprises a status associated with the initialization of the resource interface.

4. The computer platform of claim 1, wherein the initialization operation is associated with an error, and the early video content comprises a message identifying the error.

5. The computer platform of claim 1, wherein the SoC to perform the initialization operation in association with a stage of the boot, and the early video content represents a progress corresponding to the stage.

6. The computer platform of claim 1, wherein the baseboard management controller to further, responsive to receiving the code, associate the code with data representing the video content, and write the data, via the out-of-band communication channel, to a memory associated with the video display interface.

7. The computer platform of claim 6, wherein the baseboard management controller to further access a look-up table corresponding to a code-to-video content mapping to identify the data associated with the code.

8. The computer platform of claim 1, wherein:
a first memory address space of the video display interface is mapped into a second memory address space of the baseboard management controller;
the second memory address space corresponds to the out-of-band communication channel; and
the baseboard management controller to write to an address in the second memory address space to cause the video display interface to generate the video output.

9. The computer platform of claim 1, wherein:
an input/output (I/O) address space of the video display interface is mapped into a subregion of a memory address space of the baseboard management controller;
the subregion corresponds to the out-of-band communication channel; and
the baseboard management controller to write to an address in the subregion to cause the video display interface to generate the video output.

10. The computer platform of claim 1, wherein the SoC comprises a root port corresponding to the in-band communication link.

11. The computer platform of claim 1, further comprising:
a serial communication channel comprises a first serial communication interface of the SoC and a second serial communication interface of the baseboard management controller,
wherein the SoC to further to send, to the baseboard management controller, data over the serial communication channel representing the code.

12. The computer platform of claim 1, wherein the SoC comprises a semiconductor package, and the semiconductor package comprises CPU cores, a memory controller interface and a service processor.

13. A method comprising:
responsive to a request to boot a host of a computer platform, performing, by a server-on-a chip (SoC) of the computer platform, initialization operations;
responsive to performing the initialization operations, generating, by the SoC, a display command corresponding to a video content item;
subsequent to the initialization operations, executing, by a processing core of the SoC, system firmware, wherein executing the system firmware results in a discovery of a video display interface accessible via an in-band communication channel; and
providing early video before the execution of the system firmware results in the discovery of the video display interface, wherein providing the early video comprises:
sending, by the SoC and to a baseboard management controller of the computer platform, data representing the display command; and
responsive to receiving, by the baseboard management controller, the data, communicating, by the baseboard management controller and using an out-of-band communication channel, with the video display interface to cause the video display interface to provide an output corresponding to the video content item.

14. The method of claim 13, wherein generating the display command comprises generating, by the SoC, a display command corresponding to a progress of the initialization operations.

15. The method of claim 13, wherein generating the display command comprises generating, by the SoC, a display command corresponding to an error associated with the initialization operations.

16. The method of claim 13, further comprising:
responsive to the request to boot the host, initializing, by the baseboard management controller, the video display interface to allow the video display interface to be controlled by the baseboard management controller.

17. A non-transitory storage medium that stores hardware processor-readable instructions that, when executed by a hardware processor, cause a baseboard management controller of a computer platform to:
control a video display interface of the computer platform responsive to an early stage of a boot of a host of the computer platform, wherein controlling the video display interface comprises:
receiving, from a server-on-a-chip (SoC) of the host, commands corresponding to early video content items; and
responsive to the commands, communicating, using an out-of-band communication channel, with the video display interface to cause the video display interface to provide an output corresponding to the early video content items; and
responsive to the host discovering the video display interface using an in-band communication channel associated with the video display interface, relinquish control of the video display interface so that the video display interface is controlled by the host.

18. The storage medium of claim 17, wherein the instructions that, when executed by the hardware processor, further cause the baseboard management controller to:
responsive to receiving a given command of the commands, access a mapping to map the given command to video content data corresponding to a given early video content item of the early video content items; and
write, via the out-of-band communication channel and to the video display interface, the data corresponding to the given early video content item.

19. The storage medium of claim 17, wherein the instructions that, when executed by the hardware processor, further cause the baseboard management controller to cease controlling the video display interface responsive to receiving, from the host, a notification that the host is taking over control of the video display interface.

20. The storage medium of claim 17, wherein the instructions that, when executed by the hardware processor, further cause the baseboard management controller to communicate, using the out-of-band communication channel, with the video display interface to cause the video display interface to display at least one of a progress of an initialization by the SoC, a graphical image associated with the SoC or an error associated with an operation performed by the SoC.
